(19) United States
(12) Patent Application Publication
(10) Pub. No.: US 2011/0080278 A1
(43) Pub. Date: Apr. 7, 2011

(54) System And Method For Customizing An Information Display Within A Vehicle

(75) Inventors: Dale Scott Crombez, Livonia, MI (US); David Crist Gabriel, Royal Oak, MI (US)

(73) Assignee: FORD GLOBAL TECHNOLOGIES, LLC, Dearborn, MI (US)

(21) Appl. No.: 12/574,321

(22) Filed: Oct. 6, 2009

(51) Int. Cl. B60Q 1/00

(52) U.S. Cl. 340/438

(57) ABSTRACT

A display system having an information display configured to display at least one digital indicator. The display system may be configured to receive one or more customization settings indicative of a type, quantity, and placement of at least one digital indicator. A controller may transmit the customization settings to the information display so that at least one digital indicator is shown using the customization settings.

### BACKGROUND

1. Technical Field

One or more embodiments of the present disclosure relate to a system and method for customizing an information display within a vehicle.

2. Background Art

Vehicles, whether passenger or commercial, include a number of gauges, indicators, and various other displays to provide the vehicle operator with information regarding the vehicle and its surroundings. With the advent of new technologies, such as hybrid electric vehicles (HEVs), has come a variety of new gauges and information displays that help operators to better learn the operation of these vehicles that utilize new technology. For example, many HEVs incorporate gauges that attempt to provide the operator with information on the various hybrid driving states. These gauges indicate to the operator when the vehicle is being propelled by the engine alone, the motor alone, or a combination of the two. Similarly, a display may indicate when the motor is operating as a generator, and is recharging an energy storage device, such as a battery.

With regard to HEVs, it is known that sophisticated operators knowledgeable about the operation of the vehicle may require that a high level of detail be displayed to them upon an information display. Moreover, such operators may desire the flexibility to customize how certain vehicle content is displayed according to their own preferences. By displaying a greater level of detail and/or manipulating the way vehicle content is displayed, an experienced operator may more effectively use the information displayed in order to optimize the performance of the vehicle. Conversely, operators who are not as sophisticated as to the operation of HEVs, or the data presented on the information display, may prefer that only a low, or minimal, level of detail be displayed. By displaying a more simplistic level of detail, the non-sophisticated driver may be presented only the information they require to operate the vehicle in an efficient manner. Therefore, a need exists for an information display within a vehicle that allows the operator to customize the information displayed to suit their sophistication level and personal preferences.

### BRIEF DESCRIPTION OF THE DRAWINGS

FIG. 1 illustrates a schematic representation of a hybrid electric vehicle including a display system in accordance with one or more embodiments of the present disclosure;

FIG. 2 shows in detail the display system depicted in FIG. 1 in accordance with an embodiment of the present disclosure;

FIG. 3 shows in detail the display system depicted in FIG. 1 in accordance with another embodiment of the present disclosure;

FIG. 4 shows in detail the display system depicted in FIG. 1 in accordance with yet another embodiment of the present disclosure;

FIG. 5 shows in detail the display system depicted in FIG. 1 in accordance with still yet another embodiment of the present disclosure; and

FIG. 6 is a simplified, exemplary flow chart depicting one or more embodiments of the present disclosure described herein.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

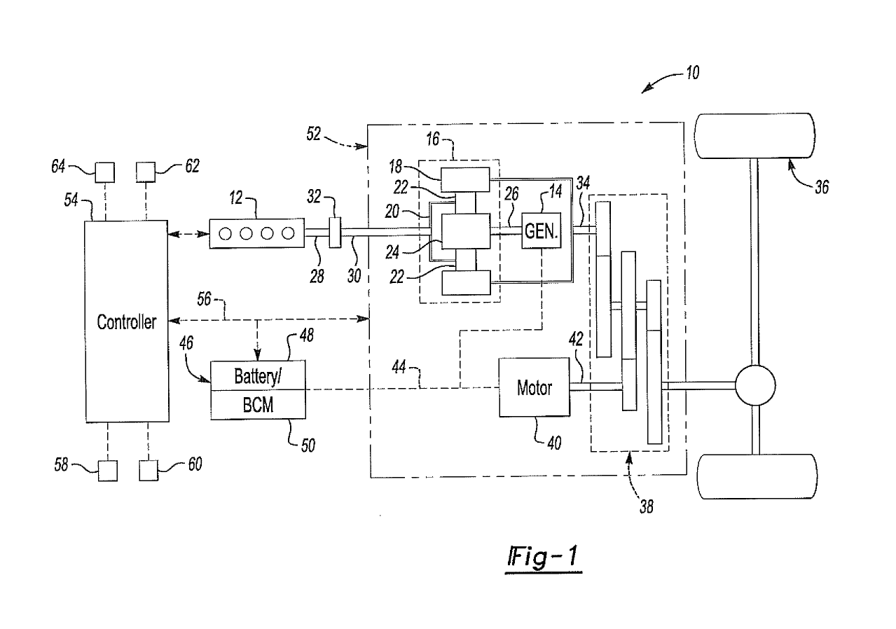

FIG. 1 shows a schematic representation of a vehicle 10 according to one or more embodiments of the present application. The vehicle 10 may include an engine 12 and a first electric machine, or generator 14. The engine 12 and the generator 14 may be connected through a power transfer arrangement, which in this embodiment, is a planetary gear arrangement 16. Of course, other types of power transfer arrangements, including other gear sets and transmissions, may be used to connect the engine 12 to the generator 14. Furthermore, the planetary gear arrangement 16 may include a ring gear 18, a carrier 20, planet gears 22, and a sun gear 24.

The generator 14 can also output torque to a shaft 26 connected to the sun gear 24. Similarly, the engine 12 can output torque to a crankshaft 28, which is connected to a shaft 30 through a passive clutch 32. The clutch 32 may provide protection against over-torque conditions. The shaft 30 may be connected to the carrier 20 of the planetary gear arrangement 16, and the ring gear 18 may be connected to a shaft 34, which is connected to a first set of vehicle drive wheels, or primary drive wheels 36, through a gear set 38.

The vehicle 10 may include a second electric machine, or motor 40, which can be used to output torque to a shaft 42 connected to the gear set 38. Other vehicles within the scope of the present application may have different electric machine arrangements, such as more or fewer than two electric machines. In the embodiment shown in FIG. 1, the electric machine arrangement (i.e. the motor 40 and the generator 14) can both be used as motors to output torque. Alternatively, each can also be used as a generator, outputting electrical power to a high voltage bus 44 and to an energy storage system 46, which includes a battery 48 and a battery control module (BCM) 50.

The battery 48 may be a high voltage battery that is capable of outputting electrical power to operate the motor 40 and the generator 14. The BCM 50 acts as a controller for the battery 48. Other types of energy storage systems can be used with a vehicle, such as the vehicle 10. For example, a device such as a capacitor can be used, which, like a high voltage battery, is capable of both storing and outputting electrical energy. Alternatively, a device such as a fuel cell may be used in conjunction with a battery and/or capacitor to provide electrical power for the vehicle 10.

As shown in FIG. 1, the motor 40, the generator 14, the planetary gear arrangement 16, and a portion of the second gear set 38 may generally be referred to as a transmission 52. To control the engine 12 and components of the transmission 52 (i.e., the generator 14 and motor 40) a vehicle control system, shown generally as controller 54, may be provided. Although it is shown as a single controller, it may include multiple controllers which may be used to control multiple vehicle systems. For example, the controller 54 may be a vehicle system controller/powertrain control module (VSC/PCM).

The vehicle 10 may further include a vehicle bus 56 (e.g., a controller area network (CAN) bus or the like). The vehicle bus 56 may allow multiple systems and devices in the vehicle to communicate with each other. For instance, the vehicle bus 56 may permit the controller 54 to communicate with the transmission 52 and the BCM 50. Any number of other devices may include controllers capable of communicating via the vehicle bus 56. For example, an engine control unit (ECU) may communicate with the controller 54 and may perform control functions on the engine 12. In addition, the transmission 52 may include a transmission control module (TCM), configured to coordinate control of specific components within the transmission 52, such as the generator 14 and/or the motor 40. Some or all of these various controllers can make up a control system in accordance with the present application. Although illustrated and described in the context of the vehicle 10, which is an HEV, it is understood that embodiments of the present application may be implemented on other types of vehicles, such as those powered by an internal combustion engine alone or an electronic motor alone.

Also shown in FIG. 1 are simplified schematic representations of a braking system 58, an accelerator pedal 60, and an air conditioning system 62. The braking system 58 may include such things as a brake pedal, position sensors, pressure sensors, or some combination of the two, as well as a mechanical connection to the vehicle wheels, such as the wheels 36, to effect friction braking. One or more embodiments of the present application further contemplate that the braking system 58 may also include a regenerative braking system, wherein braking energy is captured and stored as electrical energy in the battery 48. Of course, it should be noted that a regenerative braking system other than an electrical regenerative braking system may also be included as part of the braking system 58 (e.g., a hydraulic regenerative braking system, mechanical regenerative braking system, or the like). Similarly, the accelerator pedal 60 may include one or more sensors, which, like the sensors in the braking system 58, communicate with the controller 54.

The air conditioning system 62 also communicates with the controller 54. The on/off status of the air conditioning system can be communicated to the controller 54, and can be based on, for example, the status of an operator actuated switch, or the automatic control of the air conditioning system 62 based on related functions such as window defrost. In addition to the foregoing, the vehicle 10 may include a display system 64 that may be used to display one or more vehicle operating conditions or other vehicle-related information.

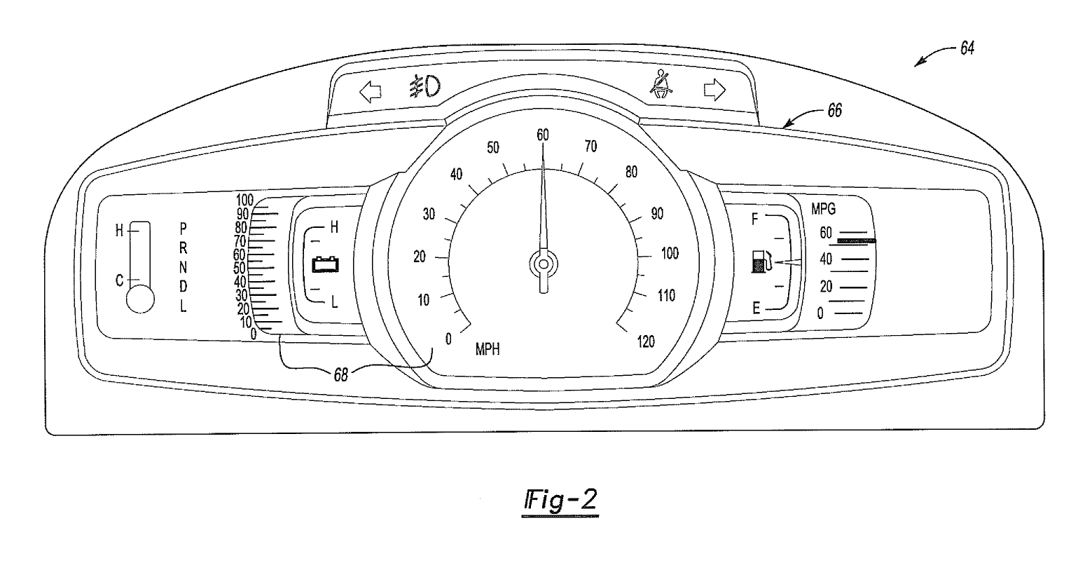

FIG. 2 illustrates the display system 64 according to one or more embodiments of the present disclosure. The display system 64 may include an information display 66 that may be customized to display one or more digital indicators 68. The information display 66 may display the digital indicators 68 using a liquid crystal display (LCD), a plasma display, an organic light emitting display (OLED), or any other display suitable to display digital indicators. Furthermore, the information display 66 may be positioned within an instrument display panel, an overhead display panel, a dashboard display panel, or any other display panel suitable for displaying vehicle operating parameters using digital indicators 68.

The present disclosure contemplates that the digital indicators 68 may display the vehicle operating parameters using a graphical representation of a virtual lamp, a bar graph, a needle gauge, a histogram, an image, iconography, or any other graphical representation suitable to display vehicle operating conditions using a digital indicator. In addition, the present disclosure contemplates that the digital indicators 68 may display the vehicle operating parameters using a numerical and/or text representation. As described in further detail below, the display system 64 may allow the operator to configure the type of digital indicators 68, the quantity of digital indicators 68, and/or the placement of the digital indicators 68 displayed on the information display 66. Moreover, the display system 64 may allow the operator to configure how available vehicle-related content is displayed.

The display system 64 may further include a control system, which, for reference purposes, may be the controller 54 described in FIG. 1. Alternatively, the display system 64 may be provided with its own dedicated control module. The controller 54 may be configured to receive sensed and/or non-sensed inputs that relate to current operating conditions of the vehicle 10. More particularly, the controller 54 may receive sensed and/or non-sensed inputs indicative of current operating conditions via the vehicle bus 56. For example, by accessing the vehicle bus 56, the controller 54 may receive vehicle speed, fuel consumption, temperature, engine information (e.g., engine on, engine off, engine starting, RPM, engine load and/or power), motor information, battery information, braking information (e.g., operation of the friction brake system and the regenerative brake system), or any other input which may be available by accessing the vehicle bus 56.

The controller 54 may also be configured to receive one or more customization settings indicative of the type, quantity, and placement of the digital indicators 68 displayed. Moreover, the controller 54 may provide outputs to the information display 66 such that the information display 66 displays at least one digital indicator 68 using at least one of the customization settings.

The display system 64 may further include a storage device (not shown) which may be used to store the customization settings indicative of the type, quantity, and placement of the digital indicators 68 to be displayed on the information display 66. The storage device may be part of the controller 54 or may be an external device accessible by the controller 54. The storage device may be an electrically erasable and programmable read-only memory (EPROM), a secure digital (SD) card, a flash memory drive, a magnetic hard drive, or any other form of non-volatile and/or volatile storage device suitable for storing customization settings. The controller 54 may be further configured to recall from the storage device the customization settings. Moreover, the controller 54 may transmit the customization settings to the information display 66 so that the vehicle operating conditions are displayed on the information display 66 according to at least one of the customization settings.

The storage device may be configured to store customization settings individually tailored for one or more operators. As such, an operator may generate and store personal customization settings (i.e., a user profile) indicative of the type, quantity, and placement of the digital indicators 68 to be displayed on the information display 66. A particular customization setting or profile may be selectively retrieved from the storage device by an operator. Alternatively, a particular customization setting corresponding to the current driver may be automatically retrieved according to known passive driver identification techniques, such as those disclosed in U.S. patent application Ser. No. 12/139,005, entitled “SYSTEM AND METHOD FOR PROGRAMMING KEYS TO VEHICLE TO ESTABLISH PRIMARY AND SECONDARY DRIVERS” and filed on Jun. 13, 2008, which is hereby incorporated by reference in its entirety.

For instance, each driver of a vehicle may be assigned a key or fob having its own identity. Moreover, the key/fob may include a transponder that transmits a radio frequency (RF) signal to the vehicle. The identity of the key/fob (and, thus, the driver) may be ascertained by interrogating RF data transmitted from the transponder. A driver's profile may be linked or otherwise associated with the key/fob's identity. A passive anti-theft controller, passive entry passive start controller, or other suitable device is generally configured to receive the RF data from the key and compare such data to known values to determine the driver's identity. As a result, message signals indicating the driver's identity can be transmitted to various controllers/modules in the vehicle, such as controller 54. Once the driver's identity is known, the driver's personal customization settings or user profile may be retrieved. Once retrieved, either actively or passively, the controller 54 may transmit the customization settings to the information display 66 so that at least one digital indicator 68 is displayed on the information display 66 according to the retrieved customization settings corresponding to the present driver.

The storage device may also store a default customization setting. The default customization setting may be preset by the manufacturer or dealer of the vehicle 10. Alternatively, the default customization setting may be set by the operator. Once programmed, the default customization setting may be transmitted to the information display 66 so that at least one digital indicator 68 is displayed on the information display 66 using the default customization settings. Alternatively, the display system 64 may be configured so that the default customization setting may be the customization setting last employed during the previous ignition cycle.

The present disclosure further contemplates providing an operator the capability of generating and storing customization settings indicative of the type, quantity, and placement of the digital indicators 68 using a software application. The software application may further be configured so that one or more digital indicators 68 may be stored in the memory of the display system 64. As is further described below, the operator may be provided the capability of generating customization settings for one or more of the digital indicators 68 using the software application.

The software application may further be configured so that one or more pre-programmed digital indictors 68 may be selected. The pre-programmed digital indicator 68 may be represented graphically as a bar graph, needle gauge, histogram, or the like. For example, a pre-programmed digital indicator 68 may be selected to display when the vehicle 10 is operating the regenerative braking system or the friction braking system. Once the desired pre-programmed digital indicator 68 is selected, the software application may further be configured so that the digital indicator 68 may be adjusted to a particular location on the information display 66.

The software application may also be configured so that one or more of the digital indicators 68 may be customized. Again, the digital indicator 68 may be represented graphically as a bar graph, needle gauge, histogram, or the like. The software application may further be configured so that the selected digital indicator 68 may be customized using one or more inputs available via the vehicle bus 56. For example, the operator may want to generate a digital indicator 68 which displays the percentage of time that the vehicle 10 may be traveling in electric mode. As such, the software application may be configured so that inputs may be selected from the vehicle bus 56 pertaining to an engine state and speed of the vehicle 10. The software application may then map the inputs to a selected digital indicator 68. Furthermore, the software application may be configured so that the digital indicator 68 may be adjusted and displayed at a particular location upon the information display 66.

The software application for customizing the information display 66 may be installed on an on-board computer or a remote computing device, such as a laptop, desktop, personal digital assistant (PDA), cell phone, or the like. Alternatively, the software application may be an Internet or web-based software application. As such, the display system 64 may include a wireless transceiver configured to access the web-based software application over the Internet from the vehicle. Once accessed, the software application may be configured to generate one or more customization settings indicative of the type, quantity, and placement of the digital indicators 68 to be displayed on the information display 66. Once generated, the customization settings may be downloaded to the vehicle and stored to the storage device. Alternatively, customization of the information display 66 may occur away from the vehicle using a remote computing device via an installed or web-based software application.

The software application may be configured so that a custom digital indicator may be downloaded or otherwise stored to the storage device. The custom digital indicator may then be mapped to display a vehicle operating parameter or information. As described above, the software application may be configured so that the custom digital indicator may be mapped to display vehicle operating parameters or information using one or more inputs available via the vehicle bus 56. Of course, the data retrieved from the vehicle bus 56 may undergo some processing (e.g., filtering, converting, translating, calculating, conditioning, etc.) before being displayed. Lastly, the software application may be configured so that custom digital indicator may be adjusted and displayed at a particular location upon the information display 66.

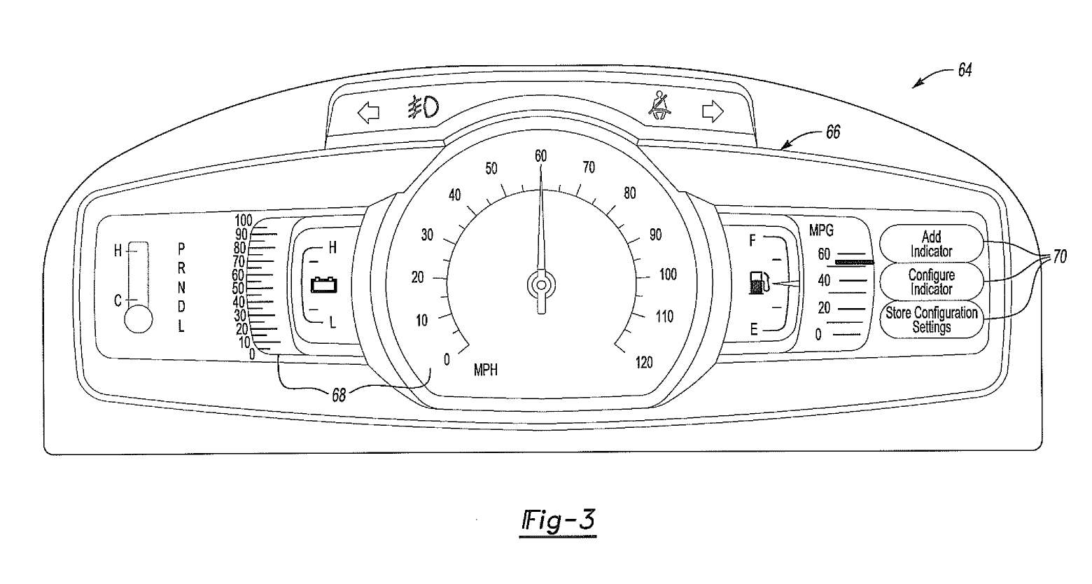

With reference to FIG. 3, the present disclosure contemplates that the information display 66 may comprise a touch screen display. The touch screen display may include one or more inputs 70 positioned upon the information display 66. The inputs 70 may be a graphical representation of a keypad, button, knob or any other graphical representation capable of being displayed upon an information display. Furthermore, the inputs 70 may also allow the capability of generating a customization setting indicative of the type, quantity, and placement of at least one digital indicator 68. The controller 54 may receive the configuration setting generated using the inputs 70. Once received, the controller 54 may transmit the customization setting to the information display 66 so that at least one digital indicator is displayed on the information display 66 using the customization settings.

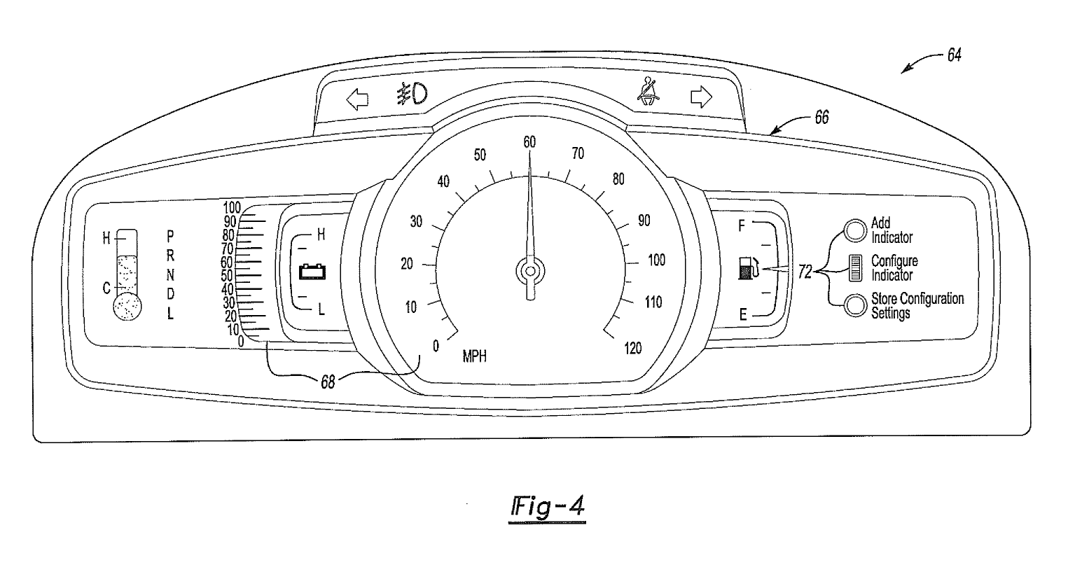

Alternatively, FIG. 4 illustrates one or more physical inputs 72 that may be positioned within the vehicle 10. The physical inputs 72 may be positioned at a location within the vehicle 10 suitable for configuring the type, quantity, and placement of the digital indicators 68 displayed. For example, the physical inputs 72 may include a keypad, buttons, or knobs positioned upon a dashboard console, a center console, an overhead console or any other location within the vehicle 10. The controller 54 may again receive the configuration setting from the physical inputs 72. Once received, the controller 54 may transmit the customization setting to the information display 66 so that at least one digital indicator is displayed on the information display 66 using the customization settings.

The present disclosure further contemplates that the software application may be configured to generate and store customization settings indicative of the type, quantity, and placement of the digital indicators 68 using a voice recognition system (not shown). The voice recognition system may include a voice-activated receiver for receiving audible customization settings indicative of the type, quantity, and placement of the gauges 68 displayed on the information display 66. As such, the voice recognition system may include a series of audible commands that may be used to generate a configuration setting. More particularly, the audible commands may be used to generate a configuration setting indicative of the type, quantity, and placement of at least one digital indicator 68 displayed on the information display 66.

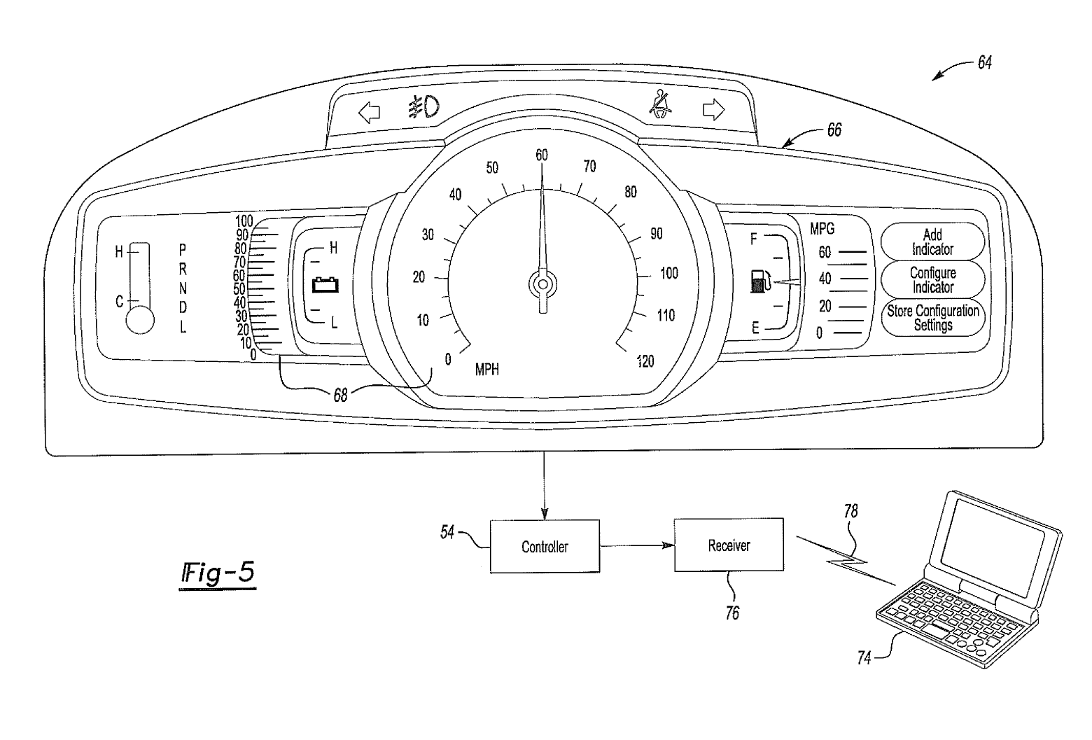

With reference to FIG. 5, the software application may further be configured to run on a remote digital device 74 which may include a personal computer, personal data assistant (PDA), a cellular phone, or any other digital device capable of running a software application. The present disclosure further contemplates that the software application may be an Internet based software application. As such, the digital device 74 may include hardware configured to access the Internet based software application. The operator may use the digital device 74 to generate, store, or retrieve one or more customization settings indicative of the type, quantity, and placement of the digital indicators 68 to be displayed on the information display 66.

As stated above, the software application may be a web-based application. More particularly, the software application may be a web site (e.g., an application store) configured so that digital indicators 68 may be uploaded and/or downloaded for use in the vehicle 10. The digital indicators 68 may be uploaded to the web site by the manufacturer of the vehicle 10, the dealer of the vehicle 10, or by other vehicle operators. For example, an operator may create a customized digital indicator 68 that displays a particular vehicle operating parameter or information about the vehicle 10 (e.g., when the regenerative brake is being operated). Once configured, the customized digital indicator 68 may then be uploaded to the web site using the digital device 74. Once uploaded, other operators, dealers or manufacturers may access the web site and may download the customized digital indicator 68 for use in the vehicle 10. Moreover, dealers and manufacturers may make additional digital indicators available to vehicle operators via the website.

The display system 64 may further include a receiver 76 configured to receive a signal 78 from a source originating external to the vehicle, such as the digital device 74. The signal 78 may include the customization settings generated using the software application. The display system 64 may also be configured to store the received customization settings to the storage device.

As shown, the signal 78 may be a wireless signal transmitted by the digital device 74. Accordingly, the receiver 76 may be configured to receive wireless signals. Likewise, the digital device 74 may include hardware configured to transmit the signal 78 to the receiver 76 using a wireless connector that may include a wireless network card, wireless USB, Bluetooth, or any other hardware suitable for transmitting a wireless signal to a receiver.

Although depicted in FIG. 5 as a wireless signal, the signal 78 received by the receiver 76 from the digital device 74 may also be a wired signal. For example, the digital device 74 may include hardware configured to transmit the signal 78 to the receiver 76 using a universal serial bus (USB) connector, a serial connector, or any other hardware suitable for transmitting a wired signal to a receiver. The signal 78 may also be transmitted to the receiver 76 using an intermediate medium. For example, the receiver 76 may be a memory storage reader and the signal 78 may be transferred from the digital device 74 using a memory storage device, such as an SD memory card, a compact flash memory card, or any other suitable memory storage device capable of storing customization settings.

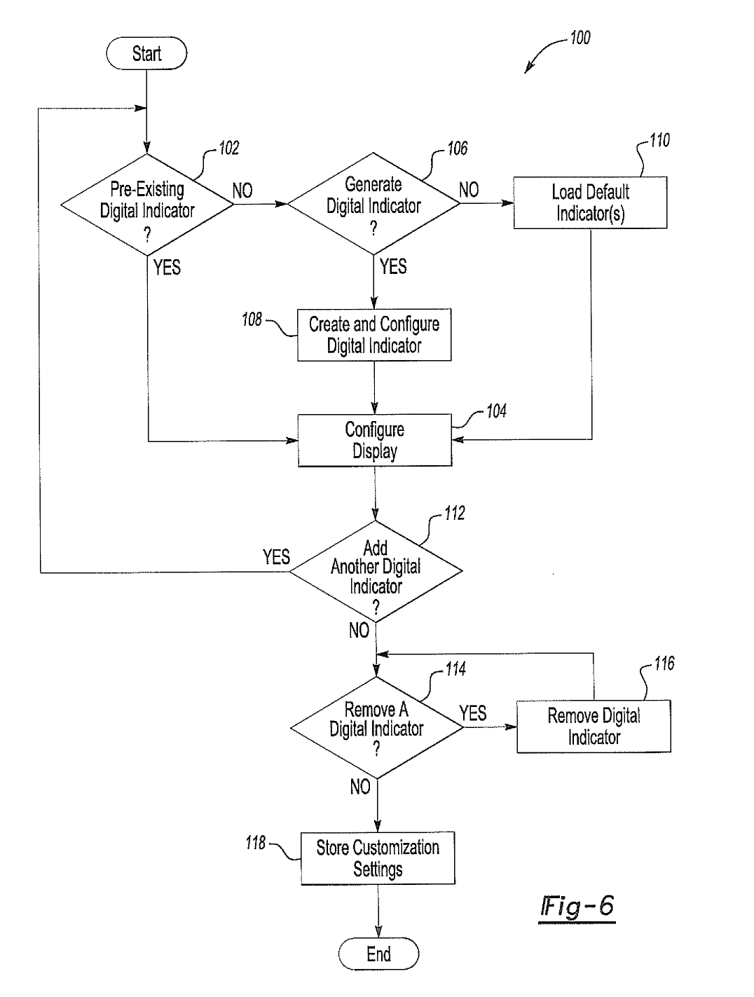

FIG. 6 illustrates an exemplary, flow diagram 100 depicting a method according to one or more embodiments of the present application. More specifically, FIG. 6 shows exemplary steps that may be provided by a software to guide an operator through the process of customizing the information display 66. However, it should be noted that the flow diagram 100 illustrated in FIG. 6 is merely exemplary and the operation, function, or steps of the flow diagram 100 may be performed in a fashion other than the order described herein.

Flow diagram 100 may begin at step 102 where the software application may be configured to select a digital indicator 68 from a set of existing digital indicators that may be stored in the storage device of the display system 64 or stored remotely and made available through the software application. As described above, the software application may be installed on the remote digital device or may be a web-based application that can be accessed by the vehicle or the remote digital device by connecting to an internet. As is further described above, a preexisting digital indicator may be graphically represented as a keypad, button, knob or any other graphical representation capable of being displayed upon an information display. The digital indicator 68 may also be already configured to display a particular vehicle operating parameter(s) or other vehicle-related information. For example, the operator may want to display a digital indicator 68 that shows the engine temperature of the vehicle 10. As such, the operator may navigate the software application (e.g., using the “soft” or physical inputs 70, 72) in order to select a digital indicator 68 that may be pre-configured to show the engine temperature and may be graphically represented as a thermometer. Moreover, the digital indicator 68 may be pre-configured to acquire the information pertaining to the engine temperature from the vehicle bus 56. If it is determined that the preexisting digital indicator has been selected, the method may proceed to step 104. However, if no preexisting digital indicator 68 is chosen, the method may proceed to step 106.

In step 106, it can be determined whether an operator would like to design a new digital indicator. If so, the method may proceed to step 108 in which a new indicator may be created and configured. In particular, an operator may modify an existing digital indicator to display different content in a similar way or the same content in a different way, for example. Rather than modify an existing digital indicator, an operator may be permitted design a new digital indicator from virtual scratch. For instance, an operator may be able to select various templates, parts, components or other items from a library of display elements when creating a custom indicator. An operator may also choose how the elements are assembled and interact. Moreover, an operator can determine the vehicle parameters or information to be mapped to one or more of the display elements. Once created and configured, the new indicator may be generated and tested using sample data to simulate its behavior so the operator can confirm that the digital indicator works as intended. Once a new digital indicator is generated and configured, the method may proceed to step 104.

On the other hand, if it is determined at step 106 that the operator does not want to create and add a new digital indicator, then the method may proceed to 110. At step 110, one or more default digital indicators may be loaded for display on the information display 66. In this regard, the software application ensures that a digital indicator for a minimal requirement of information to be displayed is included in the customized display profile. The method may then proceed to step 104.

At step 104, the software application may be configured to adjust and display a digital indicator at a particular location upon the information display 66 based upon operator input. For example, the operator may want to display digital indicator illustrating vehicle temperature in the right lower corner of the information display. Once the location of the digital indicator 68 is chosen, the flow diagram may proceed to step 112.

At step 112, the software application may be configured so that more than one digital indicator 68 may be displayed. If additional digital indicators 68 are to be displayed, the method may return to step 102. However, if additional digital indicators 68 are not selected for display, the method may proceed to step 114.

The software application may be configured to remove one or more of the digital indicators 68 from the information display 66 based upon operator input. At step 114, if it is determined that a digital indicator has been selected for removal, the method may proceed to step 116 in which the software application removes the subject indicator from the current customization profile. Once the digital indicator 68 is removed from the information display 66, the method may proceed to step 118. However, if no digital indicators 68 are selected for removal, the method may proceed directly to step 118.

At step 118, the customization settings indicative of the type, quantity, and location of the one or more digital indicators 68 saved and stored. The customization settings may be stored in the storage device. Alternatively, the software application may be accessed with the remote digital device 74. The display may then be customized remotely with digital device 74 and the customization setting may be transferred, transmitted or downloaded to the receiver 76 via signal 78. Once downloaded, the controller 54 may receive the customization settings from the receiver 76 and store the customization settings to the storage device.

While the best mode for carrying out the invention has been described in detail, those familiar with the art to which this invention relates will recognize various alternative designs and embodiments for practicing the invention as defined by the following claims.

What is claimed:

1. A vehicle display system comprising:
a display including at least one digital indicator;
a receiver configured to receive a customization setting from a source originating external to the vehicle; and
a controller configured to transmit a signal so that the at least one digital indicator is shown on the display according to the customization setting.

2. The system according to claim 1, wherein the customization setting is indicative of a type of digital indicator to be displayed on the display, a quantity of digital indicators to be displayed on the display, and a placement of the at least one digital indicator on the display.

3. The system according to claim 2, wherein the customization setting is generated remotely with a software application for customizing the display according to operator preferences.

4. The system according to claim 3, wherein the type of digital indicator is selected from a set of existing digital indicators provided through the software application.

5. The system according to claim 4, wherein the type of digital indicator is created by an operator using the software application to generate a new digital indicator.

6. The system according to claim 1, further comprising a voice-activated receiver configured to receive audible customization settings.

7. The system according to claim 1, wherein at least one customization setting is a default customization setting and the controller is configured to receive information pertaining to the default customization setting when the vehicle is started.

8. The system according to claim 1, wherein the display further includes a touch screen configured to receive customization settings from an operator.

9. The system according to claim 1, wherein the controller is further configured to receive and process information pertaining to operation of the vehicle from a vehicle bus.

10. The system according to claim 9, wherein at least a portion of the information received from the vehicle bus and processed by the controller is mapped to the at least one digital indicator according to the customization setting.

11. The system according to claim 10, wherein the one or more of the digital indicators are customizable using the information received from the vehicle bus.

12. A display method for a vehicle comprising:
receiving a display customization setting from a source originating external to the vehicle; and
transmitting a signal so that at least one digital indicator is shown on a display according to the customization setting.

13. The method according to claim 12, wherein the customization setting is indicative of a type of digital indicator to be displayed on the display, a quantity of digital indicators to be displayed on the display, and a placement of the at least one digital indicator on the display.

14. The method according to claim 13, wherein the customization setting is generated remotely with a software application for customizing the display according to operator preferences.

15. The method according to claim 14, further comprising receiving and processing information pertaining to operation of the vehicle from a vehicle bus.

16. The method according to claim 15, further comprising mapping the processed information to the at least one digital indicator according to the customization setting.

17. A display system comprising:
an information display configured to display at least one digital indicator;
a transceiver configured to connect to an internet; and
a controller configured to:
download and store a customization setting from a server located on the internet to a storage device, wherein the customization setting is indicative of a type, quantity, and placement of the at least one digital indicator; and
transmit a signal so that the at least one digital indicator is shown on the information display according to the customization setting.

18. The system according to claim 17, wherein the controller is further configured to receive information pertaining to operation of the vehicle from a vehicle bus.

19. The system according to claim 17, wherein the information display displays an internet software application accessed with the transceiver, and the customization setting is received from the server using the internet software application.

20. The system according to claim 17, wherein the internet software application is further configured to customize at least one of the digital indicators using information available from the vehicle bus.
